(19) United States
(12) Patent Application Publication
(10) Pub. No.: US 2007/0120359 A1
(43) Pub. Date: May 31, 2007

(54) Reminder system

(76) Inventors: Edward P. Busam, Mason, OH (US); Diana W. Juratovac, Columbus, OH (US)

Correspondence Address: THOMPSON HINE L.L.P., P.O. BOX 8801, DAYTON, OH, 45401-8801, US

(21) Appl. No.: 11/606,487

(22) Filed: Nov. 30, 2006

Related U.S. Application Data
(60) Provisional application No. 60/741,033, filed on Nov. 30, 2005.

(51) Int. Cl. B42D 15/00

(52) U.S. Cl. 283/81

(57) ABSTRACT

A bound component including a plurality of pages and at least one reminder strip coupled to the plurality of pages. The reminder strip is separable from the bound component, and once the strip is separated from the bound component the strip is wrappable around the wrist of a user. The bound component further includes a plurality of stickers coupled to the plurality of pages such that each sticker is separable from the plurality of pages and adhereable to the wrapped reminder strip to secure the reminder strip in the wrapped configuration.

This application claims priority to provisional patent application Ser. No. 60/741,033, filed Nov. 30, 2005, the entire contents of which are hereby incorporated by reference.

The present invention is directed to a reminder system, and more particularly, to a reminder system in the form of a bound component for dispensing wrist reminders.

### BACKGROUND

Notebooks, binders and the like are widely used by students, professionals and other users in lectures, classrooms, business meetings, etc. During the use of such materials, it is often desired to make a written notation or reminder. For example, with existing components a user may write a reminder in the margin of a notebook, on a loose piece of paper, etc. However, such written reminders can be easily overlooked, misplaced or lost. Users may also desire to make written reminders in a variety of other settings. Accordingly, there is a need for an improved device and method for making written reminders.

### SUMMARY

The present invention is an improved device and method for making written reminders. In one embodiment the invention is a bound component including a plurality of pages and at least one reminder strip coupled to the plurality of pages. The reminder strip is separable from the bound component, and once the strip is separated from the bound component the strip is wrappable around the wrist of a user. The bound component further includes a plurality of stickers coupled to the plurality of pages such that each sticker is separable for the plurality of pages and adhereable to the wrapped reminder strip to secure the reminder strip in the wrapped configuration.

In another embodiment the invention is a bound component including a plurality of pages and at least one reminder strip coupled to the plurality of pages. The reminder strip is separable from the bound component, and once the strip is separated from the bound component the strip is wrappable around the wrist of a user. The bound component further includes a cover coupled to the plurality of pages and having at least one pocket located thereon. The pocket is configured to receive a separated reminder strip therein such that at least part of the separated reminder strip is visible through the pocket.

### BRIEF DESCRIPTION OF THE DRAWINGS

FIG. 1 is a front perspective view of one embodiment of the reminder system of the present invention, shown in its closed position;

FIG. 2 is a front perspective view of the reminder system of FIG. 1, shown in its open position and a reminder being written upon and separated;

FIG. 3 is a front perspective view of reminder system of FIG. 2; with the reverse side of the reminder of FIG. 2 being written upon;

FIG. 4 is a front perspective view of the reminder system of FIG. 3, with reminders inserted into the front cover;

FIG. 5 is a front perspective view of the reminder system of FIG. 4, with the front cover in its closed position;

FIG. 6 is a front perspective view of the reminder system of FIG. 1, with a sticker sheet bound thereto;

FIG. 7 is an underside front perspective view of a wrist reminder being wrapper around the wrist of a user;

FIG. 8 is a front perspective view of the wrist reminder of FIG. 7;

FIG. 9 is a front perspective view of another embodiment of the reminder system of the present invention;

FIG. 10 is a front perspective view of another embodiment of the reminder system of the present invention, shown in its closed position; and

FIG. 11 is a front perspective view of the reminder system of FIG. 10, shown in its open position.

### DETAILED DESCRIPTION

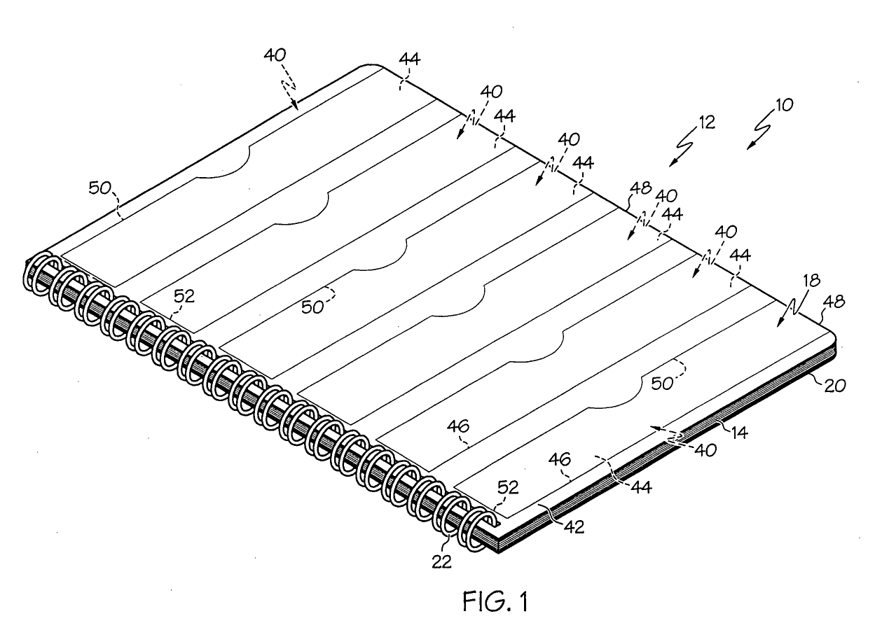

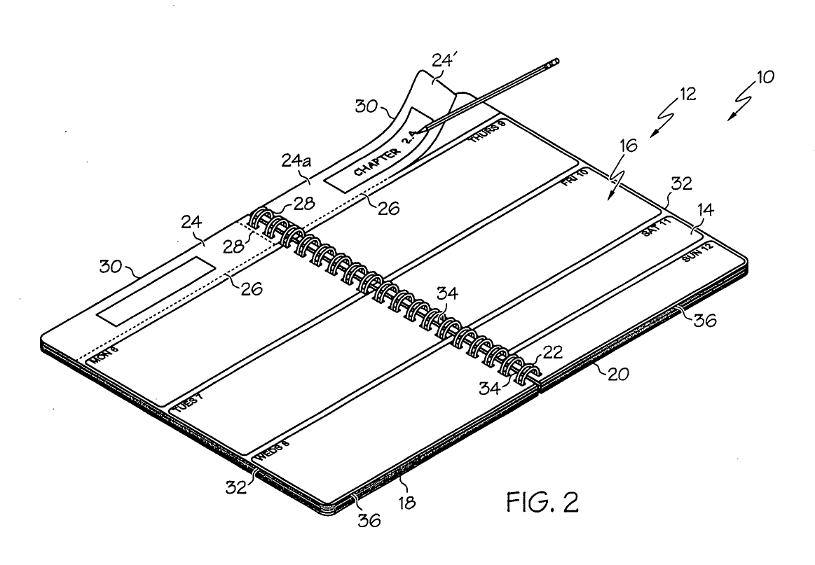

As best shown in FIG. 1, in one embodiment the wrist reminder system 10 of the present invention may take the form of a bound component 12 such as a planner, notebook, journal, diary, notepad or the like with a plurality of bound pages, papers or sheets 14. In the illustrated embodiment, the bound component 12 takes the form of a planner, in which case each of the sheets 14 includes date indicia 16 printed thereon with various spaces for the user to write planning text or notes (see FIGS. 2-4). However, the sheets 14 may have various other indicia, or may have no indicia, printed thereon. Each of the sheets 14 may be made of standard pulp-based or cellulose-based paper or generally water absorbent paper such that the sheet can written upon by a wide variety of media, including ink, pencil, marker and the like.

The bound component 12 may include a front cover 18 and a rear cover 20 bound to the sheets 14 by a binding mechanism 22. Each of the front 18 and/or rear covers 20 may have a greater thickness and/or stiffness than the sheets 14, and may have about the same size and shape as the sheets 14 to provide protection to the sheets 14. In the illustrated embodiment, the binding mechanism 22 is a twin-wire coil binding mechanism, although the binding mechanism 22 can take a variety of other forms, including but not limited to a spiral wire, adhesive bindings, book-style bindings, clips, prongs, clasps and the like.

In one embodiment each sheet 14 includes a reminder strip 24 located thereon or formed therein. Each reminder strip 24 may be formed at the upper portion of the associated sheet 14, and may be defined by a pair of generally perpendicular tear guidelines 26, 28. The tear guidelines 26, 28 can take the form of perforation lines, score lines, score-slit lines, areas of weakness, crease lines, combinations of these features, and the like. In any case the tear guidelines 26, 28 provide a line along which the sheet 14 is predisposed to tear. The tear guidelines 26, 28 and outer edges of the sheet 14 define a closed shape, such as a rectangle, which defines the reminder strip 24.

Each longitudinal tear guideline 26 extends parallel to, but spaced apart from, an upper edge 30 of the associated sheet 14, and intersects an outer free edge 32 of the sheet 14 that is opposite an inner, bound edge 34 thereof. Each lateral tear guideline 28 extends generally parallel to the inner edge 34 of the associated sheet 14. Each lateral tear guideline 28 is generally perpendicular to, and intersects, the upper edge 30 of the associated sheet 14 and the longitudinal tear guideline 26. The inner tear guideline 28 is located adjacent to, and extends parallel to, the binding mechanism 22 and allows the reminder strip 24 to be removed without having to remove the reminder strip 24 from the binding mechanism 22.

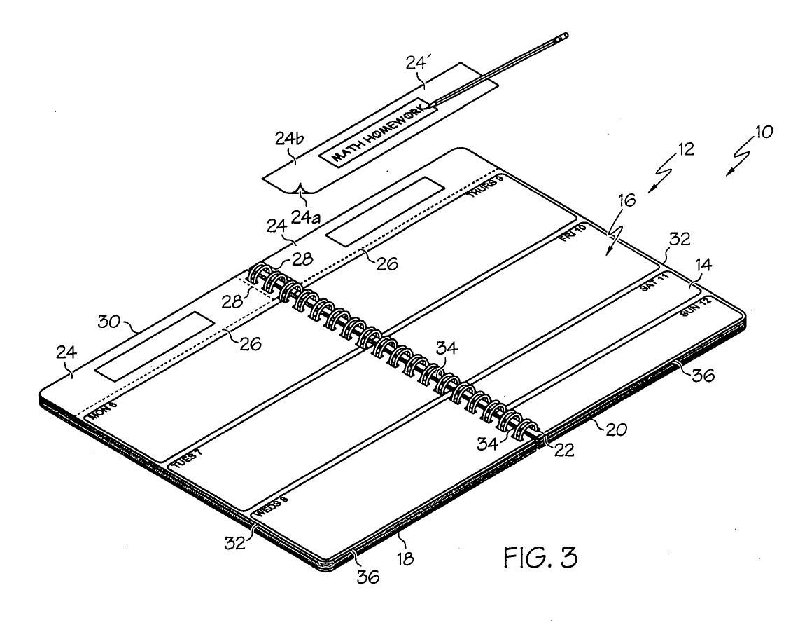

Each reminder strip 24 provides an area upon which text, reminders or indicia can be written. The reminder strip 24 can then be torn along the tear guidelines 26, 28 to separate the reminder strip 24 from the associated sheet 14. For example, FIG. 2 illustrates a reminder strip 24′ with the text “Chapter 2.4” being written on a front side 24a thereof. Alternately, text, reminder or indicia can be written on the reminder strip 24 after the strip 24 is separated. In addition, if desired indicia can be written on only one side, or both sides, of the strip 24. FIG. 3 illustrates the strip 24′ with the text “Math Homework” written on a rear side 24b thereof.

In the illustrated embodiment, each reminder strip 24 is shown as being located along the top edge of the associated sheet 14. However, the reminder strips 24 can be located at various locations on the associated sheet 14, including along the bottom 36 of the sheet 14, the outer free edge 32 of the sheet 14, although each reminder strip 24 can be entirely internal to a sheet 14 if desired. In addition, each sheet 14 may include more than one reminder strip 24, and some sheets 14 may not include any reminder strips 24 formed therein.

In an alternate embodiment, as shown in FIG. 9 each reminder strip 24 may be “pre-formed” and may not need to be torn along any tear guidelines 26, 28. In this case each reminder strip 24 may be directly bound to the binding mechanism 22 along part of the length of the binding mechanism 22, and each sheet 14 is directly bound to another adjacent portion of the binding mechanism 22. In this case the reminder strips 24 and sheets 14 are independently pivotable about the binding mechanism 22. Each reminder strip 24 can be separated from the binding mechanism 22 by manually pulling the strip 24 away from the binding mechanism 22.

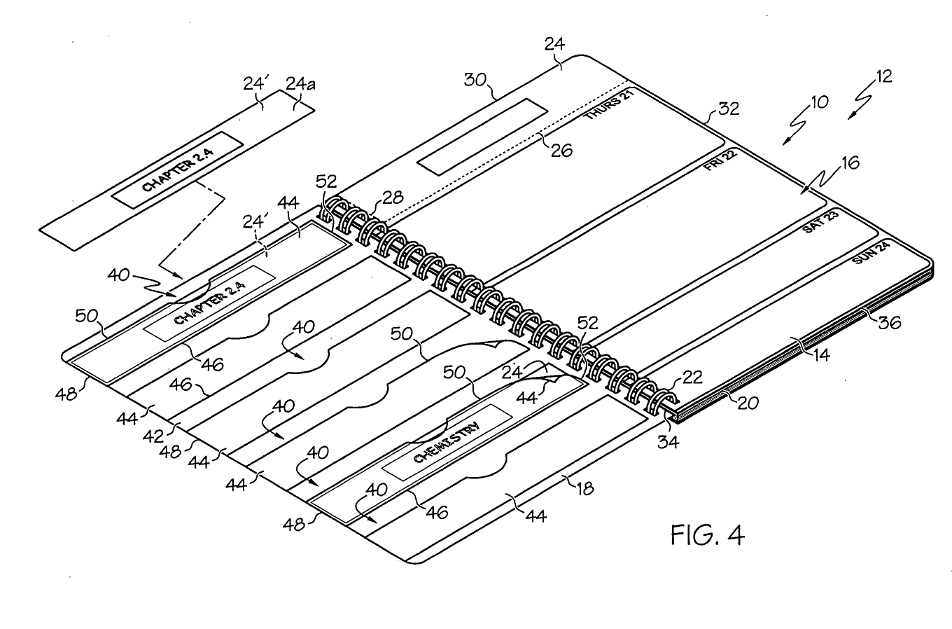

As best shown in FIG. 4, the front cover 18 may include a plurality of pockets or slots 40 formed therein or thereon, where each pocket 40 is configured to closely receive one of the reminder strips 24 therein. The front cover 18 may include a main panel 42 that is made of a generally translucent or transparent material. The main panel 42 may have a plurality of retaining panels 44 coupled thereto by any of a variety of methods, such as adhesives, welding, heat sealing or seaming, or the like. Each retaining panel 44 defines a pocket 40 between the retaining panel 44 and the main panel 42. If desired, each retaining panel 44 may also be made of a generally translucent or transparent material.

Each retaining panel 44 may be coupled to the main panel 42 along two edges; in the illustrated embodiment the bottom 46 and outer side 48 edges are directly coupled to the main panel 42 and the top 50 and inner side 52 edges are not directly coupled to the main panel 42 to provide access to the pocket 40. However, if desired each retaining panel 44 may be coupled to the main panel 42 along three edges thereof. In the illustrated embodiment, the front cover 18 includes six pockets 40 such that six reminder strips 24 can be received in the front cover 18, although the number and placement of pockets 40 can be varied as desired.

As best shown in FIGS. 4-6, each pocket 40 can receive a reminder strip 24 therein. Portions of each retaining panel 44 can be pulled away from the main panel 42 along edges 50, 52 (see FIG. 4) to allow a reminder strip 24 to be inserted in the associated pocket 40. Each reminder strip 24 may have a length and width that is at least about 90% of the length and width of each pocket 40, and/or no more than 110% of the length and width of each pocket 40, such that the pocket 40 closely receives the reminder strip 24 therein. Each reminder strip 24 can also be larger than the associated pocket 40 and protrude slightly beyond the associated pocket 40.

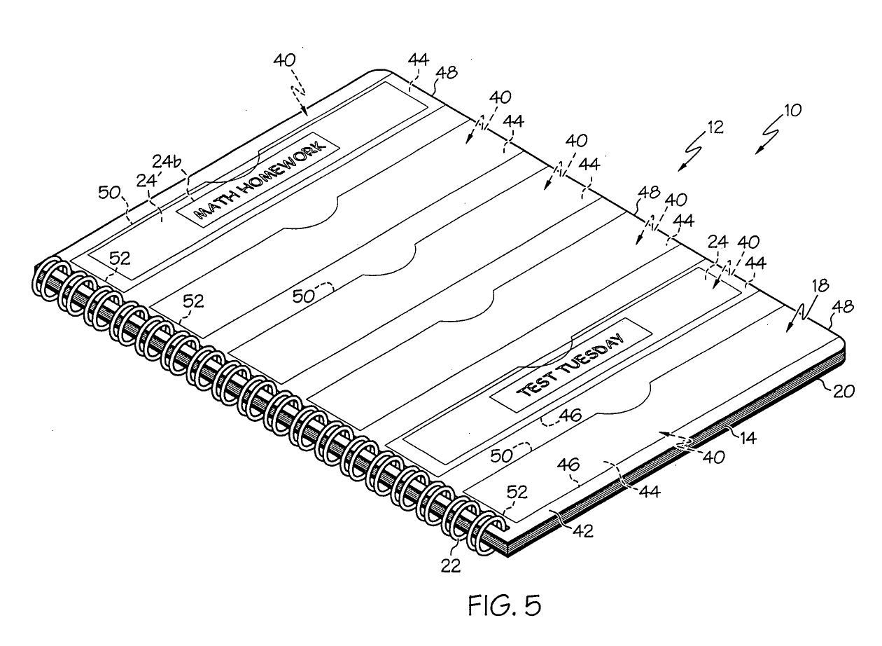

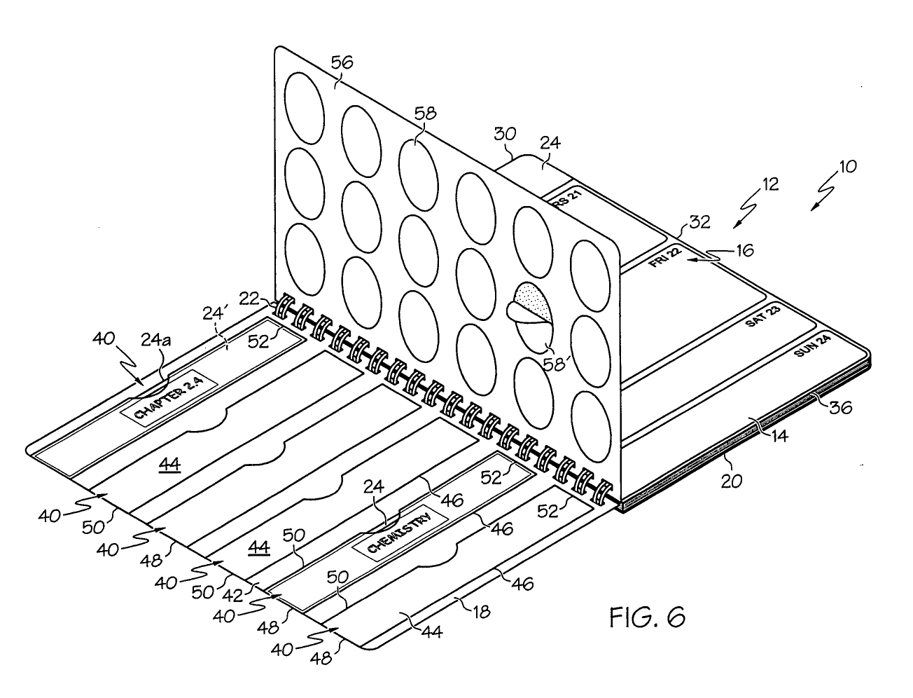

As can be seen in FIG. 5, when the main panel 42 is made of generally transparent or translucent material, any text, reminders or indicia written on one side of the reminder strip 24 are visible through the main panel 42 and cover 18. As can be seen in FIGS. 4 and 6, when the retaining panels 44 are made of generally transparent or translucent material, any text, reminders or indicia written on the other side of the reminder strip 24 are visible through the retaining panels 44 when the bound component 10 is opened. For example, in FIG. 4 the front face 24a of strip 24′ is visible, and in FIG. 5 the rear face 24b is visible.

In this configuration more urgent reminders or public indicia can be written on the side of the reminder strips 24 visible through the main panel 42, and less urgent reminders or more private matters can be written on the side of the reminder strips 24 visible through the retaining panels 44. Alternately, if desired, the retaining panels 44 and/or the main panel 42 may be made of generally opaque material to limit the ability to see certain or both sides of the reminder strips 24 positioned in the pockets 40. Thus, each pocket 40 is defined by a pair of opposed panels 42, 44 and at least one of the panels 42, 44 may be generally translucent to allow at least part of the reminder strip 24 to be visible through the pocket 40.

The pockets 40 may be able to be accessed from either the outer side or the inner side of the front cover 18. For example, in the illustrated embodiment the retaining panels 44 are located on an inner surface of the main panel 42 such that the retaining panels 44 are positioned between the main panel 42 and the pages 14 when the bound component 10 is closed. However, if desired this configuration may be reversed such that the retaining panels 44 are coupled to an outer surface of the main panel 42. In this case the main panel 42 is positioned between the retaining panels 44 and the pages 14 when the bound component 10 is closed.

The bound component 10 allows a user to write reminder indicia on the reminder strips 24 as desired, or as other entries are being written in the sheets 14. The reminder strips 24 can then be removed from the associated sheets 14 or from binding mechanism 22 and inserted into the pockets 40 of the front cover 18 for display until the reminder is no longer needed.

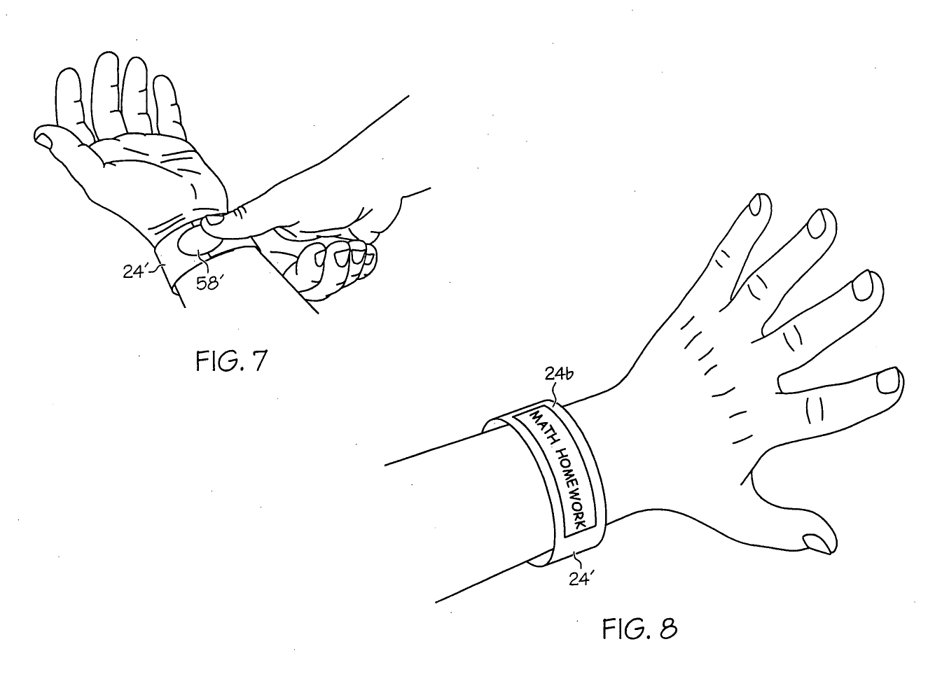

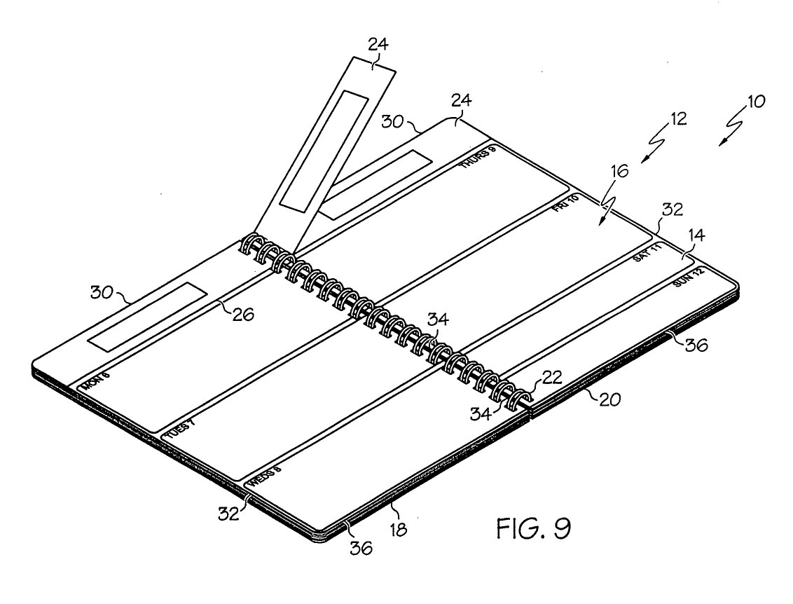

As shown in FIGS. 7 and 8, rather than sliding the reminder strip 24 into a pocket 40 on the front cover 18, the reminder strip 24 may be mounted to the wrist or other part of a user. In particular, the reminder strip 24 can be placed on or adjacent to the wrist of the user and wrapped around the wrist to form a generally closed loop. The strip 24 may be wrapped around the wrist of a user such that the written indicia faces outwardly so that the indicia is always visible. Alternately, the strip 24 may be wrapped such that the indicia faces inwardly to protect the written indicia. Further alternately, indicia may be written on both sides of the strip 24. In this configuration more urgent reminders or public indicia can be written on the outer, more visible side of the reminder strips 24, and less urgent reminders or more private matters can be written on the inner, less visible side of the reminder strips 24.

The bound component 12 may include a plurality of stickers or sticker sheets 56 bound thereto, one of which is shown in FIG. 6. Each sticker sheet 56 provides a plurality of relatively small stickers 58 (oval stickers in the illustrated embodiment). Each sticker sheet 56 may have about the same size and shape as the sheets 14. A removed sticker 58′ can then be adhered to the reminder strip 24′ (such as the overlapping end portions of the reminder strip 24′) to secure the strip 24′ to the wrist of the wearer (see FIG. 7). The adhesive of the stickers 58 may be a pressure sensitive adhesive, and may be relatively weak (i.e., weaker than the material of the reminder strip 24) which allows the sticker 58 to be separated from the reminder strip 24 without tearing. This allows the reminder strips 24 to be re-used or inserted into the pockets 40 of the front cover 18. Alternately, the stickers 58 may have a relatively strong adhesive (i.e., stronger than the material of the reminder strip 24) such that the reminder strip 24 can be removed only by tearing the material of the strip 24 or the sticker 58.

Each reminder strip 24 may have sufficient length to be formed into a loop around the wrist of the user. The length of the strips 24 may vary depending upon the age and size of the intended user, but may have a length of at least about 6 inches, or at least about 8 inches. Each strip 24 may have a width of between about ½ inch and about 1½ inches, and more particularly about one inch. Each strip 24 should have a width that is sufficient to provide sufficient strength to the strip 24 and to provide sufficient surface area for writing thereon. Each strip 24 may have a thickness of between about 0.003 inches and about 0.0175 inches such that the strips 24 are sufficiently flexible to be manually wrapped around a user's wrist. Each strip 24 may have pre-printed indicia thereon, such as colored areas, text, ruled lines, etc. to guide a user in his or her writing on the strip 24, although the pre-printed indicia is not required.

In this manner, once the bracelet or loop is formed on the wrist of the user, the strip 24 and written indicia are carried with the user until the user removes the strip/bracelet. This method of producing reminders can replace writing on the user's hand or wrist with ink or the like which is a technique practiced by many students. The use of the strips of the present invention provides a much easier and more convenient method of creating reminders. In addition, the strips can be easily disposed of as compared to significant scrubbing often required to remove writing from a user's hand or wrist.

In another embodiment, each strip 24 may have an adhesive located thereon. The adhesive can be moisture-activated, or can be a pressure sensitive adhesive covered by a release liner. The adhesive can be located on either side of the strip 24. This allows each strip to be formed into a loop without the need for stickers or the like.

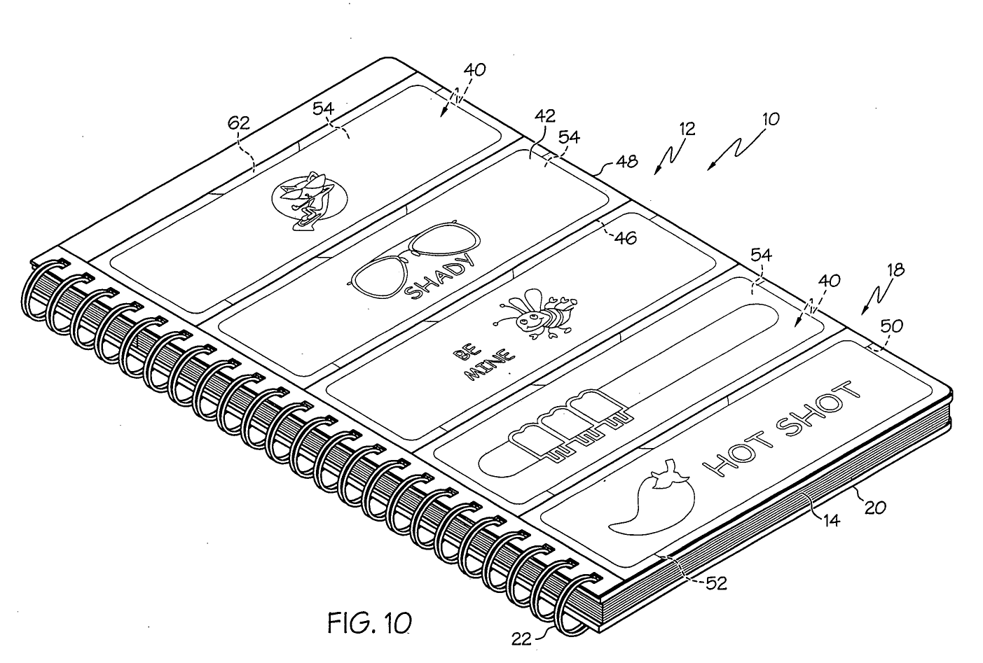

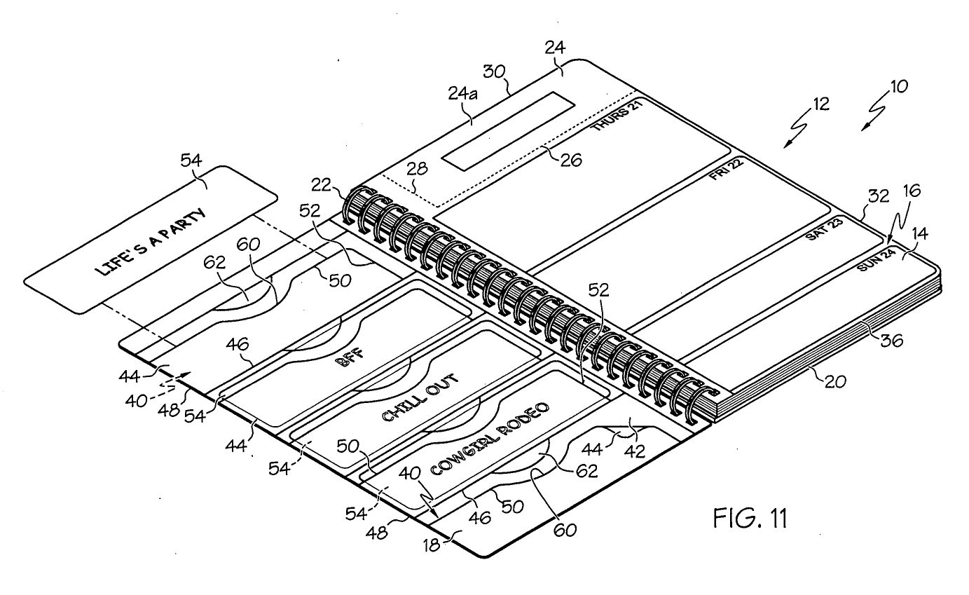

As best shown in FIGS. 10 and 11, which illustrates a slightly differently-sized embodiment of the invention, a plurality of inserts 54 may be provided, and packaged and sold with the bound component 10. Each insert 54 may be shaped and sized to be closely received in one of the pockets 40. More particularly, each insert 54 may have a length and width that is at least about 90% of the length and width of each pocket 40, and/or no more than about 110% of the length and width of the pocket 40. In the illustrated embodiment, each insert 54 is slightly larger than the pockets 40 and protrudes outwardly beyond the pockets 40. FIG. 10 illustrates an insert 54 received in each pocket 40, and FIG. 11 illustrates a bottom insert 54 removed and a top insert 54 exploded away. The strip 24 in FIG. 11. may be sized to be closely received in the pockets 40, as described above; accordingly in one embodiment the inserts 54 and strips 24 may each have roughly the same size.

Each insert 54 may have various indicia, such as text, designs, drawings, photographs, patterns, logos, phrases and the like pre-printed thereon. Such indicia may be printed on both sides thereof, or on only a single side thereof. In this manner a user can arrange the inserts 54 in various manners and arrangement in the pockets 40 to customize the cover/appearance of the bound component 12. The pockets 40/inserts 54 may cover the majority of the surface area of the front cover 18, or at least about 90% of the surface area of the front cover 18, so that the inserts 54 provide a decorative outer cover 18. The user can change the arrangement and display of the inserts 54 to change the display of bound components 10 as the user's mood changes over the day, or from day-to-day, and can be used to convey messages to friends or the like. Various combinations of inserts 54 and/or reminder strips 24 can be inserted into the pockets 44 as desired.

In addition, as shown in FIGS. 10 and 11, each retaining panel 44 may include a semi-circular notch 60 formed in the upper edge 50 thereof to allow ease of access thereto. A corresponding semi-circular retaining tab 62 may be positioned opposite the associated notch 60 and be coupled to the main panel 42 to retain each insert 54 therebelow and in the associated pocket 40.

Having described the invention in detail and by reference to the preferred embodiments, it will be apparent that modifications and variations thereof are possible without departing from the scope of the invention.

What is claimed is:

1. A bound component comprising:
a plurality of pages;
at least one reminder strip coupled to said plurality of pages, wherein said reminder strip is separable from said bound component and once said strip is separated from said bound component said strip is wrappable around the wrist of a user; and
a plurality of stickers coupled to said plurality of pages such that each sticker is separable from said plurality of pages and adhereable the wrapped reminder strip to secure the reminder strip in said wrapped configuration.

2. The bound component of claim 1 further comprising a binding mechanism, and wherein plurality of pages and said at least one reminder strip are bound together by said binding mechanism.

3. The bound component of claim 2 further comprising a sticker sheet, said sticker sheet carrying said plurality of stickers thereon, wherein said sticker sheet is bound to said binding mechanism.

4. The bound component of claim 3 wherein said sticker sheet has about the same size and shape as each of said plurality of pages.

5. The bound component of claim 1 further comprising a binding mechanism binding said plurality of pages and said plurality of stickers together.

6. The bound component of claim 1 wherein at least one of said pages includes at least one tear guideline which defines said reminder strip therein, wherein said at least one page is tearable along said tear guideline to separate said reminder strip from said at least one page.

7. The bound component of claim 6 wherein said at least one page include a second tear guideline which intersects said first tear guidelines.

8. The bound component of claim 7 wherein said reminder strip is generally rectangular and is defined by said first and second tear guidelines and at least two outer edges of the associated page.

9. The bound component of claim 7 wherein said first and second tear guidelines are generally perpendicular.

10. The bound component of claim 7 wherein said bound component includes a binding mechanism binding said plurality of pages and said plurality of stickers together, and wherein said second tear guidelines extends generally parallel to said binding mechanism, and is located adjacent to but spaced apart from said binding mechanism.

11. The bound component of claim 1 wherein each of said plurality of pages includes at least one tear guideline which defines a reminder strip therein, wherein each page is tearable along the associated tear guideline to separate the associated reminder strip from the associated page

12. The bound component of claim 1 wherein said reminder strip is made of a generally water-absorbent material so that said reminder strip is easily written upon.

13. The bound component of claim 1 further including a cover bound to said plurality of pages and having at least one pocket formed thereon, wherein said pocket is configured to closely receive said separated reminder strip therein.

14. The bound component of claim 13 wherein said pocket includes a generally translucent portion such that when said separated reminder strip is received in said pocket at least part of said reminder strip is visible through said pocket.

15. The bound component of claim 13 wherein said reminder strip has a length and a width that is at least about 90% of a length and width of said pocket.

16. The bound component of claim 1 further comprising a binding mechanism binding said page and said at least one reminder strip together, and wherein said page and said at least one reminder strip are independently pivotable about said binding mechanism.

17. A bound component comprising:
a plurality of pages, wherein at least one of said pages includes at least one tear guideline which defines a reminder strip therein, wherein said at least one page is tearable along said tear guideline to separate said reminder strip from said at least one page, and wherein said separated reminder strip is configured to be wrapped around the wrist of a user; and
a plurality of stickers coupled to said plurality of pages such that each sticker is adherable to overlapping portions of the wrapped reminder strip to secure the reminder strip in said wrapped configuration.

18. A method for using a bound component comprising the steps of:
providing a bound component including a plurality of pages, at least one reminder strip coupled to said plurality of pages, and a plurality of stickers coupled to said plurality of pages;
separating said reminder from said plurality of pages;
wrapping said reminder around a wrist; and
adhering portions of the wrapped reminder strip using one of said stickers to secure the reminder strip in said wrapped configuration.

19. The method of claim 18 wherein said separating step includes tearing one of said pages along at least one tear guideline.

20. The method of claim 18 further including the step of manually writing text on said reminder.

21. The method of claim 20 wherein said writing step is carried out before said tearing step.

22. A bound component comprising:
a plurality of pages,
at least one reminder strip coupled to said plurality of pages, wherein said reminder strip is separable from said bound component, and once said strip is separated from said bound component said strip is wrappable around the wrist of a user; and
a cover coupled to said plurality of pages and having at least one pocket located thereon, wherein said pocket is configured to receive a separated reminder strip therein such that at least part of said separated reminder strip is visible through said pocket.

23. The bound component of claim 22 wherein said cover has about the same size as each of said plurality of pages.

24. The bound component of claim 22 wherein at least one of the pages includes at least one tear guideline defining said reminder strip therein, wherein said at least one page is tearable along said tear guideline to separate said reminder strip from said at least one page.

25. The bound component of claim 24 wherein said at least one page include a second tear guideline which intersects said first tear guidelines.

26. The bound component of claim 22 further comprising a binding mechanism binding said page and said at least one reminder strip together, and wherein said page and said at least one reminder strip are independently pivotable about said binding mechanism.

27. The bound component of claim 22 wherein said pocket is configured to closely receive said separated reminder strip therein.

28. The bound component of claim 22 wherein said reminder strip has a length and a width that is at least about 90% of a length and width of said pocket.

29. The bound component of claim 22 wherein said pocket includes a generally translucent portion such that when said separated reminder strip is received in said pocket at least part of said reminder strip is visible through said generally translucent portion of said pocket.

30. The bound component of claim 22 wherein said pocket is defined by a pair of opposed panels, and wherein at least one of said panels is generally translucent such that at least part of said separated reminder strip received in said pocket is visible through said pocket through said generally translucent panel.

31. The bound component of claim 22 wherein said pocket is defined by a pair of opposed panels, wherein both of said panels are generally translucent such that at least part of said separated reminder strip received in said pocket is visible through both panels of said pocket.

32. The bound component of claim 22 wherein said pocket is accessible from an inner side of said cover.

33. The bound component of claim 22 wherein said separated reminder strip is configured to be wrapped around the wrist of a user, and wherein said bound component further includes a plurality of stickers coupled to said plurality of pages such that a sticker is adherable to overlapping portions of the wrapped reminder strip to secure the separated reminder strip in said wrapped configuration.

34. The bound component of claim 22 further comprising a plurality of said inserts, wherein each insert is closely receivable in said pocket, and wherein each insert includes pre-printed indicia located thereon.

35. A method for using a bound component comprising the steps of:
providing a bound component including a plurality of pages, a plurality of reminder strips coupled to said plurality of pages, and a cover coupled to said plurality of pages and having at least one pocket located thereon;
separating said reminder strip from said plurality of pages; and
inserting said separated reminder strip into said pocket such that said pocket closely receives said separated reminder strip therein and such that at least part of said separated reminder strip is visible through said pocket.
